(19) United States
(12) Patent Application Publication
(10) Pub. No.: US 2006/0123346 A1
(43) Pub. Date: Jun. 8, 2006

(54) Selection of delivery mechanism for text-based document

(76) Inventors: Scott Totman, Vienna, VA (US); Kerry Pearce, Leesburg, VA (US); Patrick Yann Schwermer, Hamilton, VA (US); David Gang, Oakton, VA (US); Marlon Bishop, Mountain View, CA (US); Joe Hewitt, Los Gatos, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/005,348

(22) Filed: Dec. 6, 2004

(51) Int. Cl. G06F 17/00

(52) U.S. Cl. 715/748

(57) ABSTRACT

A multipurpose text application which provides a user interface which provides a plurality of delivery mechanisms or actions for handling a text document prepared using the user interface. Actions can include text messaging, instant messaging, emailing, creating contact entries, creating calendar entries, creating journal entries, creating note or memos, creating tasks, and storing a draft of the text document. The user can select one or more actions before, during or after the text document is created. In addition, the network status of one or more intended recipients can be monitored to assist the user in selecting the action.

### BACKGROUND OF THE INVENTION

1. The Field of the Invention

The present invention relates to systems and methods for delivering text based messages. More particularly, embodiments of the invention relate to systems and methods for selecting a delivery mechanism for text based messages.

2. The Relevant Technology

The electronic age has revolutionized the way in which people communicate. In many cases, paper has been replaced with electronic text documents. However, people continue to use text-based electronic documents in much the same way that paper documents are used—to send messages to other people, to maintain lists for organizational purposes, to keep journals, and the like. Various text-based software applications have been developed to enable people to continue to use text-based documents for these various purposes. For example, email has become a primary means for people to send text-based electronic messages to each other. Instant messaging and text messaging have developed as alternative ways to send text-based electronic messages. Various organizational information software applications have been developed to assist people in organizing personal contact, calendar, journal, and task information.

Generally, when a person is drafting a text document, the person must select a software application which is preconfigured to perform a particular action associated with the text document. For example, when a person desires to draft a letter to print out and send via regular mail, the person accesses a word processing application. The person then proceeds to prepare a letter using the functions available on the word processing application. Suppose, however, that the person, after drafting the letter, decides to send the letter or a variation of the letter via instant messaging. The person must open a separate instant messaging application, determine if the intended recipient is online, cut and paste the original letter into the instant messaging window (or alter the text), and then send the instant message. Alternatively, the user may decide to abandon the originally drafted letter and draft a newer, perhaps shorter message in the instant messaging application.

Next, suppose the user is drafting an instant message, only to find out, after taking the time to draft the message, that the instant message cannot be sent because the recipient has gone off-line. In this situation, the user often decides to send an e-mail instead of the instant message. In order to send the e-mail, the user must first open an e-mail application, copy and paste the text from the instant message interface (or redraft the message) into the e-mail application and then send the e-mail through electronic messaging means.

In another example, a user sends an instant message regarding, for example, c z an appointment with the recipient. If the user desires to record this appointment in their calendar, the user must first open a calendar application that is independent of the instant messaging application, and then create an entry to record the appointment that was already written in the instant message.

In the examples cited above, the user has lost time switching between various text-based applications. In the first example, the user had to switch from a word processing application to an instant messaging application. In the second example, the user was required to switch between an instant messaging application and an e-mail application. In the third example, the user was required to open two separate applications to perform two indirectly related actions. In addition, the user is inconvenienced by having to essentially redraft the entire message or resort to cutting and pasting, which still requires effort from the user.

### BRIEF SUMMARY OF THE INVENTION

These and other limitations are overcome by embodiments of the present invention, which relate to systems and methods for delivering text-based messages through various delivery mechanisms. Embodiments of the present invention include a multipurpose text application with a user interface for preparing a text document and one or more actions, which include delivery mechanisms, for handling the text document. The actions can include, but are not limited to, text messaging, instant messaging, emailing, maintaining contact information, maintaining calendar items, maintaining journals, maintaining notes or memos, maintaining task items, and storing a draft of the text document. The user can select one or more of the actions before, during and/or after the text document is created. The user can further perform more than one action on a particular text document. In addition, the network status of one or more intended recipients can be monitored to assist the user in selecting the action. Network status can include whether the intended recipient is online, offline, connected via a wireless or mobile device, idle, online but unavailable (e.g., idle or away), and the like.

In one embodiment, a multipurpose text application is provided having a user interface. The user interface is a simple, fast word processing-based application or can communicate with an existing word processing application on the user's system. The user interface presents a text screen for allowing a user to draft a text document. The user interface typically provides at least basic functionalities of word processors, such as, but not limited to, editing, formatting, printing, and the like. The user interface includes a plurality of graphical icons or buttons which indicate one or more actions. Upon selecting one of those icons or buttons, the user interface communicates with a corresponding action modules which initiates a particular action with respect to the text document. The user interface may also include an organizational information screen that provides the user with various organization information such as contacts, calendar, journal, notes or memos, and tasks information.

The action modules can include a text messaging module, an instant messaging module, an email module, a contacts module, a calendar module, a journal module, a note or memos module, a tasks module, and a storage module. The action modules communicate with various applications, each application corresponding to a particular action module. Thus, the applications can include a text messaging application, an instant messaging application, an email application, a contacts application, a calendar application, a journal application, a note or memos application, a tasks application, and a storage application. The applications provide the functionality to complete a particular action on a text document. The applications may also associate with one or more databases which store information to assist in completing the desired action function.

Some actions are implemented in a network environment. For example, a user may desire to send a text document to one or more recipients. Thus, the present invention can enable the multipurpose text application to communicate with a network which, in turn, communicates with one or more recipients.

After the multipurpose text application is initiated, a user can draft a text document through the user interface. After the text document is drafted, an action is typically selected by the user. The user interface then communicates with an action module associated with the selected action and the action module activates a corresponding application to complete the selected action. The selected action can be influenced by external events. For example, embodiments of the present invention may monitor the network status of recipients in the context of instant messaging. If, for example, the user is notified that the intended recipient is offline, the user can select another action or delivery mechanism such as e-mail.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 shows a diagram illustrating an exemplary user interface screen according to embodiments of the present invention;

FIG. 2 shows a diagram illustrating an exemplary system and software configuration according to embodiments of the present invention; and

FIG. 3 shows a diagram illustrating an exemplary flow diagram according to embodiments of the present invention.

### DETAILED DESCRIPTION OF EXEMPLARY EMBODIMENTS

The present invention relates to systems and methods for delivering a text document and more particularly to a multipurpose text application which can implement multiple delivery mechanisms or actions for an electronic text document or other text-based message. Generally, a user drafts a text document using a text screen and then selects an action for the text document. One advantage to the present invention is that a user does not have to commit to a particular action before drafting the text document. For example, the user does not have to commit to sending the text document as an email, sending the text document as an instant message, or saving the text document as a word processing document before drafting the text document. The user can decide after the text document is created. In addition, the network status of potential recipients of the text document may be monitored in order to assist the user in selecting a particular action for the text document. The present invention thus provides a seamless approach between any potential number of actions for handling a text document that currently exists or that may be created in the future.

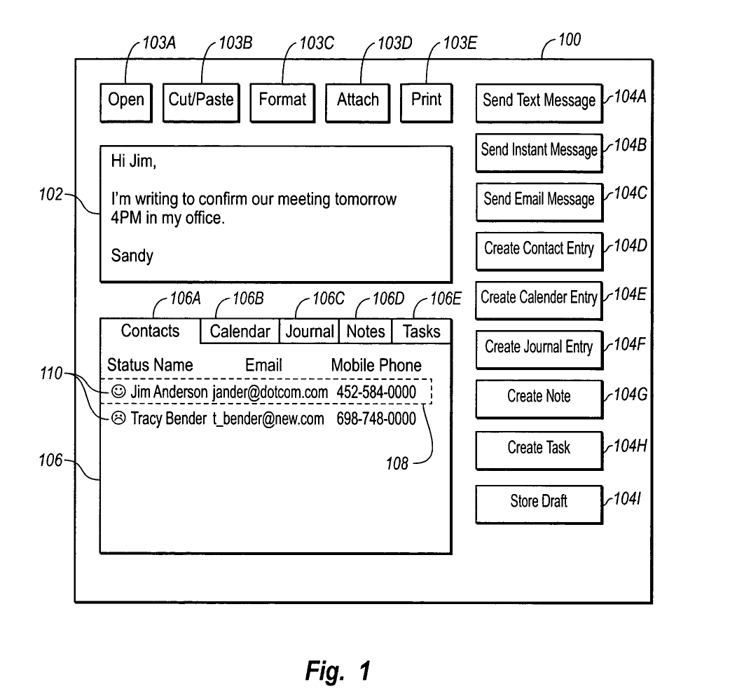

With reference to FIG. 1, the versatile nature of the multipurpose text application of the present invention is illustrated. The multipurpose text application 100, as will be described further below, includes a generally small, fast user interface which provides the basic functionality of most word processing documents. As shown in FIG. 1, multipurpose text application 100 includes a text screen 102 that appears, in one embodiment, as a blank template when first opened and allows a user to input any desired text to create a text document. Thus, the text screen 102 may also have maximizing, minimizing and scrolling capabilities if the user wants to change the viewing capabilities of the text screen, such as when the user wants to create a lengthy text document. Although not shown, various means for inputting text into the text screen 102 can be used, such as, but not limited to, a keyboard, a mouse, a stylus or other pointer (where the text screen is pressure sensitive), a joystick, and the like, whether directly or remotely connected.

The multipurpose text application 100 can exemplarily include word processing buttons 103A through 103E that provide at least basic word processing functions such as opening existing text documents (button 103A), cut and pasting (button 103B), and formatting functions (button 103C) available in most word processing applications. The multipurpose text application 100 may also include the ability to attach objects such as text and image attachments (button 103D). The multipurpose text application 100 may also include printing capability (button 103E). The multipurpose text application 100 can generally be used as a generic word processor application as well as having the additional functions provided herein. It will be appreciated that the text screen 102 can be used to provide dialogue windows for displaying files to be searched, attachments to be browsed, and/or formatting options.

On the multipurpose text application 100 are a plurality of action selection icons or buttons 104A through 104H. Before, during or after the user creates the text document, the user can then select any of the action buttons 104. As used in the present invention, the term “delivery mechanism” and “action” will be used interchangeably to refer to a potential action to be performed with a text document. The terms delivery mechanism and action are broad enough to encompass delivering a text document to a local database on the user's device or to a remote location, such as a recipient device. Thus, storing a text document in a database can also be considered an action in accordance with the scope of the present invention.

As shown in FIG. 1, any number of actions may be associated with the multipurpose text application 100. The following actions buttons 104A through 104I are provided by way of description, but not by way of limitation: sending a text message 104A, sending an instant message 104B, sending an email 104C, creating a contact entry 104D, creating a calendar entry 104E, creating a journal entry 104F, creating a note or memo 104G, creating a task item 104H and saving a draft of the text document 104I. Thus, by selecting one or more of these actions buttons 104A through 104I, the user is able to activate the applications necessary to accomplish the selected action(s). It will be appreciated that other existing or future developed actions for handling a text-based document may be included in view of the teachings herein.

In one embodiment, header fields on the text screen 102 (e.g., TO and FROM fields) are hidden to avoid the appearance that the multipurpose text application 100 can be used only for certain types of actions (e.g., composing and sending e-mail). When an action is selected, either before, during or after the text document is drafted, the text screen 102 can be modified to display the information necessary to carry out the selected action. In some cases, as will be described further below, the user may be required to produce additional information.

The multi-purpose, free-form nature of the multipurpose text application 100 thus provides a user with added freedom in switching between various types of text-based documents. The text screen 102 serves as a template for composing various types of text-based messages including, but not limited to, text messages, instant messages, and email messages. The text screen 102 is also template for entering and/or modifying a user's organizational information. Furthermore, the text screen 102 can be used to draft basic word processing documents. Thus, the user is not limited to the type of text-based document that can be created. No longer does the user need to navigate through several different applications to find an e-mail template, an instant messaging template, a contacts template, a calendar appointment template, etc. In addition, the user may use the same text document for multiple purposes using the same software application.

In the example where the user desires to draft a written letter, but then decides later to send an instant message, the user can simply select the “instant messaging” button 104B. In some cases, the user may not decide how the text document should be sent until the user has completed drafting the text document. The present invention provides the user at the outset with multiple possibilities of how to treat a text document so the user has the freedom to draft the text without committing to a particular application. This enables the user, in some cases, to change their mind mid-stream. The present invention is versatile enough that the user could select “email” button 104C before or during drafting the text document, but then change her mind and ultimately decide to select the “instant messaging” button 104B. The user is not required to cut and past the text document from the e-mail application to the instant messaging application or to retype the text document. The user only selects a different action for the text document.

In the example where the user originally desires to send an instant message to an intended recipient but learns that the intended recipient is off-line, the present invention provides the user with many alternative options for sending the text document without requiring the user to exit out of the application and find another alternative option. Thus, the user can simply select the “email” button 104C and identify the recipient.

Finally, in the example where the user sends an instant message regarding, for example, an appointment with the recipient and desires to record the appointment in their calendar, the user can simply select both the “instant messaging” button and the “create calendar entry” button without opening separate applications.

The text application 100 may also include other features which assist a user in determining and selecting an action. As shown in FIG. 1, an organizational information screen 106 can be provided allowing a user to toggle between different types of organizational information. For example, organizational information can include a contacts screen 106A, a calendar screen 106B, a journal screen 106C, a note or memos screen 106D, and a tasks screen 106E.

The contact screen 106A, for example, can include contact information for one or more contacts. The contact screen 106A can show the name, email address or mobile phone number of each contact. Exemplarily, when a user decides to deliver a text document via text messaging, instant messaging or email, the user can select or highlight one of the contacts, as indicated by the dashed line 108 surrounding the contact named Jim Anderson. The intended contact or recipient can be selected before or after the action button 104 is selected. By selecting one of the contacts, all necessary address information (e.g., email address, mobile phone number) is automatically provided and no other information need be provided from the user. In addition, as shown at the left of the two example contacts, an icon 110 can be used to indicate whether the network status of the contacts. Network status can include whether a recipient is online, offline, connected via a wireless or mobile device, idle, online but unavailable (e.g., idle or away), and the like. For example, an icon indicating a face with a smile can be used to indicate that a contact is online while an icon having a face with a frown can mean that the contact is offline. Selecting the contact having an online indicator may also provide the appropriate IP and port information in order to send instant messages to the contact.

The present invention thus enhances the efficiency of using text-based applications by providing a multipurpose text application which provides multiple options as to how to treat a text document. Because the user can select the particular action to be performed on the text document before, during and/or after the text document is drafted, the user is not required to commit beforehand to any particular action. As such, should the user change his or her mind regarding the particular action to be performed on the text document, or should the user be prevented in certain circumstances from taking a particular action on a text document, the user can easily select one of the other actions to perform on the text document.

In addition, the user may perform more than one action on a particular text document without requiring the user to open up multiple separate applications. Thus, the multipurpose nature of the text application 100 is not only longitudinal, but lateral as well. That is, the user is able to transmit text document to recipient devices in various ways, and is also able to maintain the user's own organizational information using text documents created by the present invention on the user's device.

Furthermore, the user can postpone the selection of an action until a later date. By selecting “store draft” button 104I, the user may save the draft of the text document as a local file (or remotely on another database to which the user has access), and later retrieve the text document and perform another action 104A through 104H on the text document.

Thus, the present invention provides several benefits. First, the present invention provides a multipurpose text application which eliminates the need for a user to navigate through one or more text-based applications in order to find the correct user interface to create a text document to perform a particular function. Second, the present invention allows a user to change the action mid-stream without having to access a different application. Third, the present invention allows a user to perform multiple actions on a particular text document.

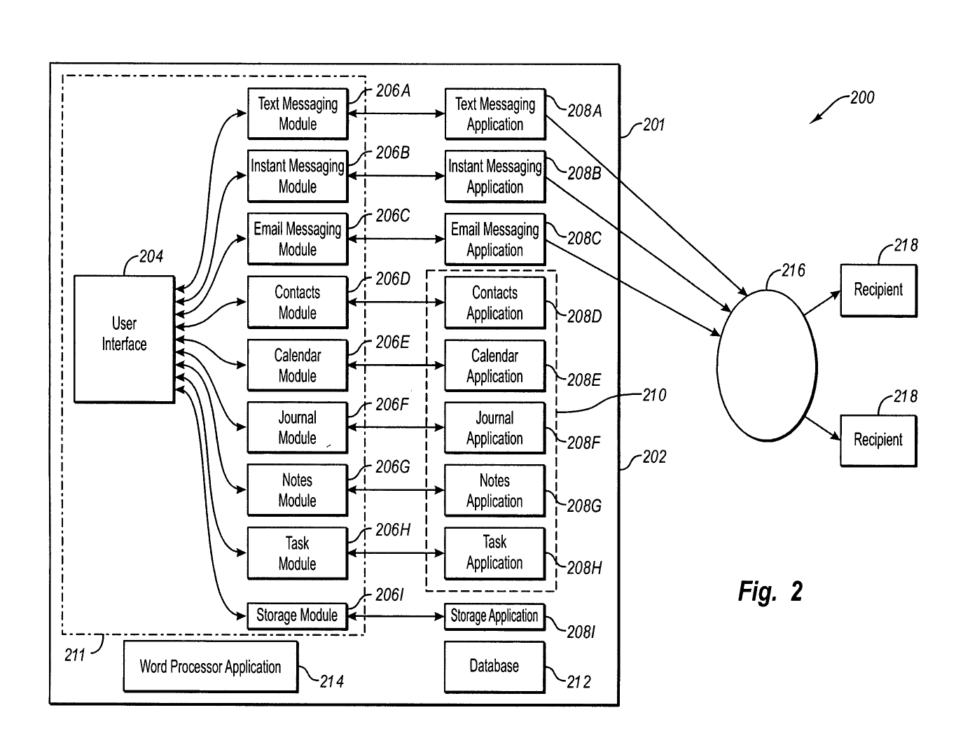

Turning now to FIG. 2, an exemplary system and software configuration 200 is provided by way of explanation and not limitation. System 200 includes a user device 201. User device 201 may include, but is not limited to, a personal computer, a hand-held computer, a laptop computer, a mobile phone, an organizational information assistant, and the like. Device 201 includes a multipurpose text application indicated by reference numeral 202.

Multipurpose text application 202 includes a user interface 204. User interface 204 provides the user interface 100 features shown in FIG. 1 including the text screen 102 and word processing buttons 103. As discussed above, user interface 204 is a generic text application which allows a user to input text to create a text document. In this embodiment, the user interface 204 communicates with a plurality of action modules 206A through 206I. Exemplarily, the action modules include a text messaging module 206A, an instant messaging module 206B, an email module 206C, a contacts module 206D, a calendar module 206E, a journal module 206F, a note or memos module 206G, a tasks module 206H, and a storage module 206I. Each of modules 206A through 206I initiates the required functions to complete the action associated with the module. The user is thus able to select one or more of the action buttons 104 (FIG. 1) to initiate action modules 206A through 206I to perform a particular action on the text document created through the user interface 204. The user interface 204 also communicates with at least some of the action modules 206 to provide the organizational information screen 106 (FIG. 1).

As further shown in FIG. 2, the text application 202 includes applications 208A through 208I that communicate with each of the action modules 206A through 206I. Exemplarily, applications 208A through 208I include a text messaging application 208A, an instant messaging application 208B, an email application 208C, a contacts application 208D, a calendar application 208E, a journal application 208F, a note or memos application 208G, a tasks application 208H, and a storage application 208I. It will be appreciated that any number of existing or future-developed action modules 206 and corresponding applications 208 may be implemented as necessary in view of the teachings of the present invention.

In some embodiments, one or more of the applications 208A through 208I may be implemented using existing applications in the art. For example, the dash line 210 represents that one or more of the applications, e.g., 208C through 208H, may be embodied in one software application. That is, the application 210 may provide the functionality for maintaining organizational information in one software application that encompasses email application 208C, contacts application 208D, calendar application 208E, journal application 208F, note or memos application 208G, and tasks application 208H. Other variations for grouping applications 208A through 208I are possible.

It is also possible for the text application 202 to be bifurcated so that a portion indicated by reference numeral 211 is located on user device 201 while the remaining components of text application 202 are located elsewhere, e.g., a remote server with which the user device 201 communicates. For example, to minimize the footprint of multipurpose text application 202 on a user's mobile phone, portion 211 could be located on the user's mobile phone and communicate with a server to provide the additional functionality of the text application 202.

As shown in FIG. 2, each of action applications 208A through 208I can access a database 212. While the database 212 is shown as a single entity, it will be appreciated that the database 212 may include one or more drives, remote or local, to which the user device 201 has access. In addition, it is possible for each action application 208A through 208I to access different databases. However, a single database 212 is illustrated simply to show that the action applications 208A through 208I are able to access some type of database.

The database 212 can store information related to each action application 208A through 208I. For example, in the case of text message application 208A, the database 212 can track mobile phone numbers. In the case of instant messaging application, the database 212 can store IP addresses and ports for various recipients. The database 212 can also be used to track the network status of one or more recipients to which the user desires to send an instant message, buddy lists, and the like. In the case of email application 208C, the database 212 can store email addresses, group lists, approved email addresses, unapproved email addresses, and the like. In the case of contact application 208D, the database 212 can store contact information such as names, addresses, telephone numbers, fax numbers, and the like. The database can similarly store information related to calendar application 208E, journal application 208F, note or memos application 208G, and/or task application 208H. Furthermore, in the situation where a user desires to save a draft of a text document, storage module 208I communicates with database 212 to store a draft.

In some embodiments, the user interface 204 can access an existing word processing application 214 residing on the user device 201. This can help to minimize the amount of code required to develop the user interface 204. It will be appreciated, however, that multipurpose text application 202 does not have to access an existing word processing application residing on the user's device, but could have all of the necessary word processing code already programmed into it.

Some of the action applications 208A through 208C allow a user to transmit a text document to one or more recipients. Thus, FIG. 2 also illustrates an exemplary network configuration. The user device 201 communicates with a network 216, which can include one or more servers. The network 216 also communicates with one or more recipient devices 218. Similar to the user device, the recipient devices 218 can include, but are not limited to, a personal computer, a hand-held computer, a laptop computer, a mobile phone, an organizational information assistant, and the like.

In view of the foregoing, system and software configuration 200 provides a user with the ability to initiate various actions for a particular text document. For example, where a user desires to send a text document via text messaging, the user interface 204 communicates with text messaging module 206A which provides the interface to a text messaging application 208A, either located on the user's device or on a remote device to which the user has access. Text messaging operates by sending a text message to a designated cellular phone number via one or more servers in the network 216 and also one or more satellites or towers (not shown). As such, a text message prepared on user interface 204 can be delivered directly to a recipient's mobile phone. As mentioned above, database 212 can be used to store mobile phone numbers for one or more intended recipients.

In addition, system and software configuration 200 can monitor the network status of one or more recipients and allow the user to select certain actions based on the network status. For example, with regard to instant messaging as an action, generally, the instant messaging application 208B connects the user device to an instant messaiging server. The instant messaging server can use proprietary protocols or a non-proprietary protocols. Once the client device connects to the instant messaging server and the user logs on with a user name and password, the user can send a text document. Generally, a user is able to send instant messages only to recipients who are also “online.” The instant messaging module 206B may thus serve to prevent a user from sending a text document from user interface 204 if the desired recipient is offline. The instant messaging module 206B may alternatively notify the user of the recipient's network status.

As in conventional instant messaging applications, in order to send an instant message, the user is required to select one or more recipients to receive an instant message. When the user indicates that the instant message be sent, the instant messaging application delivers the instant message to the recipient. In one embodiment, the instant messaging system can include obtaining the EP address and port number of the device of the recipient so that the instance message is sent directly to the recipient, allowing the system to bypass an instant messaging server. Alternatively, the instance message can be sent through the instant messaging server.

Instant messaging module 206B and instant messaging application 208B can be further operated to automatically log the user device onto an instant messaging server, even without the user typing in a user name or password (the user name and password being pre-entered into the text application 202). Thus, as long as the user is using multipurpose text application 202, the user is shown as “online” to other recipients. In addition, initiation of the user interface 204 can also automatically load a buddy list window which shows the user potential intended recipients who may also be online. As such, database 212 may maintains the recipients to whom the user has identified in a “buddy list” or an approved recipient list. Buddy lists are described in further detail in U.S. Pat. No. 6,677,968, filed Apr. 17, 2001, incorporated by reference.

Instant messaging is one example of an action that may be determined based on the network status of one or more recipients. It will be appreciated that other actions may be configured to operational dependent on the network status of one or more recipients.

With regard to email as an action, email module 208C communicates with an email application 208C either located on the user's device or on a remote device to which the user has access. The electronic messaging application 208C generally includes an inbox which holds the messages for the user, and allows the user to read, create, and/or send electronic messages to one or more recipients. The email application 208C communicates with one or more email servers on a network 216. As mentioned above, database 212 can be used to store email addresses for one or more intended recipients.

The user may also use text application 202 to maintain her organizational information. These types of actions may not be associated with a recipient, but, rather, are maintained on the user device 201. As shown in FIG. 2, a contact module 206D, a calendar module 206E, a journal module 206F, a note or memos module 206G, and task module 206H are provided which communicate with a contact application 208D, a calendar application 208E, a journal application 208F, note or memos application 208G, and a task application 208H, respectively.

When a user selects one of modules 206D through 206H, the corresponding applications 208D through 208H import the content of the text document into an appropriate organizational information entry. Organizational information for contact entries may include, but is not limited to, names, email addresses, phone numbers, addresses, and the like. Organizational information for calendar entries may include, but is not limited to, times, dates, locations, and the like. In one embodiment, the appropriate action module 206D through 206H can thus access an organizational information dialogue window from the corresponding action application 208D through 208H and insert the organizational information into the appropriate field in the organizational information dialogue window. The action module 206D through 206H may then request that the user provide or correct any missing or incorrect information in order to complete an organizational information entry.

A parser module (not shown) may provide intelligent capabilities to determining the content of the text document and what type of organizational information it contains so that the user may not even have to select one of the organizational information buttons 104D through 104H. Further details and description related to parsing text documents can be found in co-pending U.S. patent application Ser. No. ______, filed _, (attorney docket 15690.37) herein incorporated by reference in its entirety.

Thus, using a single text-based application and user interface, a user can create multiple types of text-based documents and perform various actions on these documents.

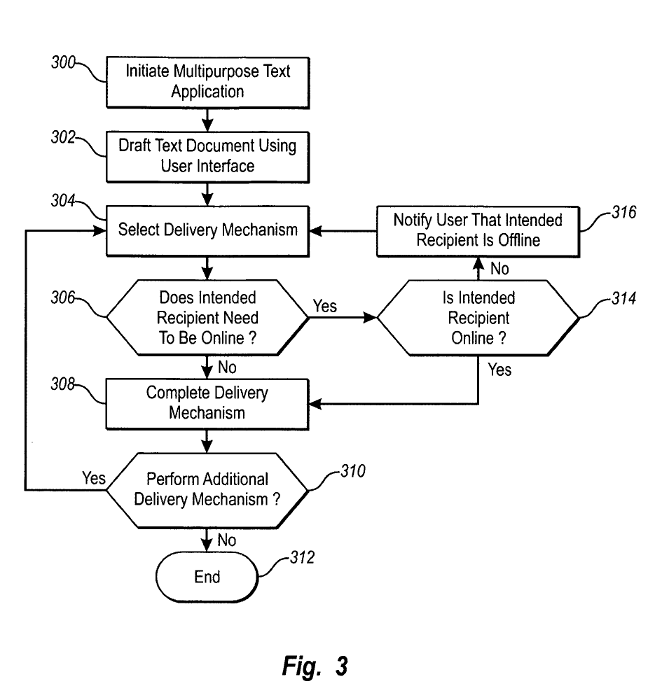

FIG. 3 illustrates one exemplary method of implementing a method for performing an action of a text document such as delivering the text document. A user typically begins by initiating a multipurpose text application 300. The user drafts a text document using the user interface 302 of the multipurpose text application. The user can select an action or delivery mechanism 304 for the text document at any time such as before, during, or after creation of the text document. As described above, the action may include text messaging, instant messaging, email, creating an organizational information entry, and the like. After the user selects a particular action, the user interface communicates the selection to the appropriate action module, which communicates with the corresponding application.

In this embodiment, the network status of one or more recipients is monitored in order to assess the user's abilities to select certain actions. A determination is made regarding whether the particular action requires that a recipient be online 306. If a recipient does not need to be online, the selected action or delivery mechanism is completed 308 using the appropriate application. The user has the opportunity to perform an additional action 310. If the user decides to perform an additional action on the text document, the process returns to selecting a delivery mechanism 304 where the user selects one or more of the actions. If the user desires no further actions on the text document, the process terminates 312.

The following steps are related to instant messaging where it is required that a recipient be online in order to complete the action. Returning to the determination regarding whether the intended recipient is online 306, if the process determines that a recipient must be online in order to perform the action, the process determines whether the recipient is indeed online 314. If the recipient is online, is the action is completed 308 using the instant messaging application. If the recipient is not online, the user is notified that the recipient is offline 316 and the user is given an opportunity to select another action 304. The process then proceeds as previously described.

It will be appreciated that the above-illustrated method may be performed in a different order. For example, the user may be notified that potential or actual recipients are online or offline. The user can then be prevented from selecting instant messaging as an action for that particular recipient(s) who is offline. Thus, determining whether a recipient is online or offline can occur before the user selects the action or even before the user begins drafting the text document. In addition, the user may select the delivery mechanism or action 304 before or during drafting the text document 302. Other configurations are also possible in view of the teachings herein.

The embodiments of the present invention may comprise a special purpose or general-purpose computer including various computer hardware. Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The following discussion is intended to provide a brief, general description of a suitable computing environment in which the invention may be implemented. Although not required, the invention has been described in the general context of computer-executable instructions, such as program modules, being executed by computers in network environments. Generally, program modules include routines, programs, objects, components, data structures, etc. that perform particular actions or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where actions are performed by local and remote processing devices that are linked (either by hardwired links, wireless links, or by a combination of hardwired or wireless links) through a communications network. In a distributed computing environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a system that includes one or more applications, each application configured to perform a particular action on a text document, a method for performing actions associated with the one or more applications on a text document without switching from one application to another application, the method comprising:
presenting a user interface to a user, the user interface including a plurality of action icons each associated with a particular action module;
receiving text from the user into a text screen of the user interface to create a text document;
receiving input from the user to select at least one action module through the plurality of icons; and
activating each application associated with the selected at least one action module, wherein each application performs a corresponding action on the text document.

2. A method as recited in claim 1, wherein presenting a user interface to a user comprises automatically connecting the user interface with a network.

3. The method as recited in claim 1, wherein presenting a user interface to a user comprises automatically connecting the user interface with the user's organizational information.

4. A method as recited in claim 3, further comprising presenting an information screen on the user interface to display organizational information to the user.

5. A method as recited in claim 1, wherein activating each application with the selected at least one action module further comprises at least one of:
activating an email application that sends the text document as an email;
activating an instant messaging application that sends the text document as an instant message;
activating a text messaging application that sends the text document as a text message;
activating a storage application that saves the text document to storage; and
activating an organizational information application to handle the text document as organizational information.

6. The method as recited in claim 1, wherein receiving input from the user to select at least one action module through the plurality of icons comprises receiving a recipient's email address input from the user.

7. The method as recited in claim 6, wherein the recipient's email address is automatically input when the user selects a recipient.

8. The method as recited in claim 1, wherein activating each application associated with the selected at least one action module, further comprises allowing the user to select another action when external circumstances do not allow the selected action to occur.

9. The method as recited in claim 8, wherein the external circumstances comprises a recipient of the action being offline from a network with which the user is associated.

10. A method for selecting a delivery mechanism for a text document after creation of the text document, the method comprising:
initiating a multipurpose text application that presents a user interface that includes a text screen to a user;
receiving text into the text screen to compose a text document, the text screen identifying a plurality of delivery mechanisms for the text document;
selecting a delivery mechanism for the text document from the plurality of delivery mechanisms, each delivery mechanism associated with a particular application; and
completing the selected delivery mechanism for the text document by activating the particular application associated with each selected delivery mechanism.

11. The method as recited in claim 10, wherein after the user selects the delivery mechanism, adjusting the text screen to include information specific to the particular delivery mechanism.

12. The method as recited in claim 10, wherein selecting a delivery mechanism comprises selecting one of a plurality of icons on the user interface corresponding to each delivery mechanism.

13. A method as recited in claim 10, further comprising presenting an information screen on the user interface to display organizational information to the user.

14. A method as recited in claim 10, wherein activating each application with the selected at least one action module further comprises at least one of:
activating an email application that sends the text document as an email;
activating an instant messaging application that sends the text document as an instant message;
activating a text messaging application that sends the text document as a text message;
activating a storage application that saves the text document to storage; and
activating an organizational information application to handle the text document as organizational information.

15. The method as recited in claim 10, wherein selecting a delivery mechanism comprises allowing the user to change the selection of delivery mechanism when external circumstances do not allow the selected delivery mechanism to occur.

16. The method as recited in claim 15, wherein the external circumstances comprises a recipient of the delivery mechanism being offline from a network with which the user is associated.

17. A method for allowing a user to draft a text document and to select one or more actions to take on the text document without the text document being dedicated to one of the actions before drafting the text document, the method comprising:
providing a user interface configured to allow a user to create a text document;
associating the user interface with two or more action modules, wherein one of the action modules is configured to initiate an instant messaging transaction; and
performing an action on the text document in accordance with a user selection of at least one of the two or more action modules.

18. The method as recited in claim 17, further comprising monitoring the network status of an intended recipient of a text document.

19. The method as recited in claim 18, further comprising identifying whether the intended recipient is online.

20. The method as recited in claim 17, wherein at least one of the two or more action modules is configured to initiate an email message transaction.

21. The method as recited in claim 17, wherein at least one of the two or more action modules is configured to initiate a text messaging transaction.

22. The method as recited in claim 17, wherein at least one of the two or more action modules is configured to initiate a contacts entry.

23. The method as recited in claim 17, wherein at least one of the two or more action modules is configured to initiate a calendar entry.

24. The method as recite in claim 17, wherein at least one of the two or more action modules is configured to initiate a journal entry.

25. The method as recited in claim 17, wherein at least one of the two or more action modules is configured to initiate a memo entry.

26. The method as recited in claim 17, wherein at least one of the two or more action modules is configured to initiate a task entry.

27. The method as recited in claim 17, wherein at least one of the two or more action modules is configured to initiate a storage transaction.

28. A system having a user device, the user device configured to allow a user to draft a text document and select between at least two actions to perform on the text document without having to open two or more separate text-based applications associated with the at least two actions, the system comprising:
a user interface configured to allow a user to draft a text document;
a first action module associated with the user interface, the first action module configured to receive the content of the text document and initiate a particular action on the text document using a corresponding first application when the first action module is selected by a user, the first action module configured to initiate an instant messaging transaction; and
a second action module associated with the user interface, the second action module configured to receive the content of the text document and initiate a particular action on the text document using a corresponding second application when the second action module is selected by a user.

29. The system as recited in claim 28, wherein the user interface, the first action module and the second action module are located on a user device and the first action application and second action application are remote from the user device.

30. The system as recited in claim 28, wherein the user interface comprises a text screen generic to the first action module and the second action module.

31. The system as recited in claim 28, wherein the user interface comprises word processing functions.

32. The system as recited in claim 28, wherein the user interface comprises an organizational information screen.

33. The system as recited in claim 28, wherein the second action module is configured to initiate one or more of:
text messaging transactions;
email transaction;
a contact entry;
a calendar entry;
a journal entry;
a memo entry;
a task entry; and
storing a draft of the text document.

34. The system as recited in claim 28, wherein a network status of a potential recipient of the text document is monitored to assist the user in selecting the first action module.
